(19) United States
(12) Patent Application Publication
(10) Pub. No.: US 2019/0012079 A1
(43) Pub. Date: Jan. 10, 2019

(54) Input Assistance Device, Smart Phone, and Input Assistance Method

(71) Applicant: Yamaha Corporation, Hamamatsu-shi (JP)

(72) Inventors: Kosuke ONOYAMA, Hamamatsu-shi (JP); Takashi OZAKI, Hamamatsu-shi (JP); Hidetake OGINO, Hamamatsu-shi (JP); Makoto KIMURA, Hamamatsu-shi (JP)

(21) Appl. No.: 16/131,687

(22) Filed: Sep. 14, 2018

Related U.S. Application Data
(63) Continuation of application No. PCT/JP2017/009945, filed on Mar. 13, 2017.

(30) Foreign Application Priority Data
Mar. 15, 2016 (JP) 2016-050417

(51) Int. Cl. G06F 3/0488; G06F 3/0482; G06F 17/27; H04M 1/725

(52) U.S. Cl. CPC G06F 3/04886; H04M 1/72519; G06F 17/276; G06F 3/0482

(57) ABSTRACT

An input assistance device includes at least one memory storing instructions and at least one processor configured to implement the stored instructions to execute a plurality of tasks. The plurality of tasks includes a display control task which causes a display device to display a plurality of first pattern images each corresponding to a different character, and by being triggered when any one of the plurality of first pattern images is designated, to display a plurality of second pattern images each corresponding to a word related to the character of the designated first pattern image surrounding the first pattern image as a reference so as to prompt an input of a word.

### CROSS REFERENCE TO RELATED APPLICATION(S)

This application is a continuation of International Patent Application No. PCT/JP2017/009945 filed on Mar. 13, 2017, which claims the benefit of priority of Japanese Patent Application No. 2016-050417 filed on Mar. 15, 2016, the contents of which are incorporated herein by reference in its entirety.

### BACKGROUND OF THE INVENTION

### 1. Field of the Invention

The present disclosure relates to a technology of assisting input of various types of data with respect to an electronic device.

### 2. Description of the Related Art

In a tablet terminal and a smart phone, a virtual keyboard called a software keyboard is generally used as an input unit to input words indicating various types of data. The virtual keyboard is realized by displaying a pattern image (hereinafter, referred to as a virtual operator) of an operator corresponding to characters such as various types of symbols, such as alphabet, syllabary, numbers, and arithmetic symbols) in a display screen of a touch panel. A user of a tablet terminal and the like can input each character of a desired word (or reading syllabary of the word) by touching the virtual operator.

In a personal computer and the like, a keyboard (hereinafter, referred to as a full-size keyboard) having about 80 to 110 keys is generally used as an input unit. However, in the tablet terminal and the smart phone, it is difficult to display a virtual keyboard having sufficient number of virtual operators like the full-size keyboard due to restrictions such as narrowness of a display screen in many cases. Therefore proposed are various techniques to enable input of words and the like, even though the virtual operators are few. As an example of the techniques, there is a technique disclosed in JP-A-2015-228154 as Patent Literature 1.

In the technique disclosed in JP-A-2015-228154, as illustrated in FIG. 7A, the respect characters “ [symbol] (a)”, “ [symbol] (ka)”, “ [symbol] (sa)”, “ [symbol] (ta)”, “ [symbol] (na)” . . . “ [symbol] (wa)”, that is, the virtual operators assigned to the head characters of columns of the Japanese syllabary are displayed in a display unit to prompt the user to input a character. For example, in a case where the user desires to input a character “ [symbol] (u)”, the user touches a virtual operator corresponding to the character “ [symbol] (a)”. When the user touches, in the technique disclosed in Patent Literature 1, as illustrated in FIG. 7B, a display content is switched to a display of the virtual operators corresponding to the respective characters of the column of “ [symbol] (a)”. The user recognizes the screen illustrated in FIG. 7B and touches the virtual operator corresponding to the character “ [symbol] (u)” to input the character.

Besides the method disclosed in JP-A-2015-228154, there are modes such as inputting the character by a toggle input system with respect to the virtual operators corresponding to the respective characters of “ [symbol] (a)”, “ [symbol] (ka)”, “ [symbol] (sa)”, “ [symbol] (ta)”, “ [symbol] (na)” . . . “ [symbol] (wa)” (see FIG. 8A), or inputting the character by a flicking input system with respect to the virtual operators (see FIG. 8B). In a case where a character “ [symbol] (ku)” is input by the toggle input system, the virtual operator corresponding to the character “ [symbol] (ka)” is continuously touched three times by a fingertip or the like. In the Japanese syllabary, the “ [symbol] (ka)” column consists of five characters of “ [symbol] (ka)”, “ [symbol] (ki)”, “ [symbol] (ku)”, “ [symbol] (ke)”, and “ [symbol] (ko)” in this order. In a case where the character “ [symbol] (ku)” is input by the flicking input system, the virtual operator corresponding to the character “ [symbol] (ka)” is touched to display the respective operators corresponding to the respective characters of “ [symbol] (ki)”, “ [symbol] (ku)”, “ [symbol] (ke)”, and “ [symbol] (ko)” up and down and right and left by the fingertip or the like (see FIG. 8B), and the user slides the fingertip or the like (flicking operation) in a direction of the virtual operator corresponding to the character “ [symbol] (ku)”.

Patent Literature 1: JP-A-2015-228154

### SUMMARY OF THE INVENTION

In the input modes illustrated in FIGS. 7A to 8B, there is a need to perform the operation plural times to input one character. Further, it takes much time to input a word containing a plurality of characters.

A non-limited object of the present invention is to provide a technology that enables an efficient input of words indicating various types of data with respect to an electronic device which uses a virtual keyboard as an input device.

According to an embodiment of the present invention, there is provided an input assistance device. The input assistance device includes at least one memory storing instructions; and at least one processor configured to implement the stored instructions to execute a plurality of tasks. The plurality of tasks includes a display control task which causes a display device to display a plurality of first pattern images each corresponding to a different character and, by being triggered when any one of the plurality of first pattern images is designated, to display a plurality of second pattern images each corresponding to a word related to the character of the designated first pattern image surrounding the first pattern image as a reference so as to prompt an input of a word.

According to an embodiment of the present invention, there is provided a smart phone having functions of the input assistance device.

According to an embodiment of the present invention, there is provided an input assistance method. The input assistance method includes displaying a plurality of first pattern images each corresponding to a different character by a display device, and displaying, by being triggered when any one of the plurality of first pattern images is designated, a plurality of second pattern images each corresponding to a word related to the character of the designated first pattern image surrounding the first pattern image as a reference so as to prompt an input of a word.

### BRIEF DESCRIPTION OF THE DRAWINGS

In the accompanying drawings:

FIG. 1 is a perspective view illustrating an exterior of an electronic device 10 according to an embodiment of the present invention;

FIG. 2 is a block diagram illustrating an exemplary configuration of the electronic device 10 according to an embodiment of the present invention;

FIG. 3 is a diagram illustrating an example of a management table which is stored in a nonvolatile storage unit 134 of the electronic device 10 according to an embodiment of the present invention;

FIG. 4 is a diagram illustrating an example of a screen which is displayed according to a setting assistance program in a display unit 120a by a control unit 100 of the electronic device 10 according to an embodiment of the present invention;

FIG. 5 is a flowchart illustrating a flow of an input assistance process which is performed according to an input assistance program by the control unit 100 according to an embodiment of the present invention;

FIGS. 6A and 6B are diagrams illustrating an example of a candidate selection screen which is displayed in the display unit 120a by the control unit 100 in order to prompt input of a word in the input assistance process according to an embodiment of the present invention;

FIGS. 7A and 7B are diagrams illustrating an example of a virtual keyboard of the related art; and

FIGS. 8A and 8B are diagrams illustrating an example of a virtual keyboard of the related art.

### DETAILED DESCRIPTION OF THE EXEMPLARY EMBODIMENTS

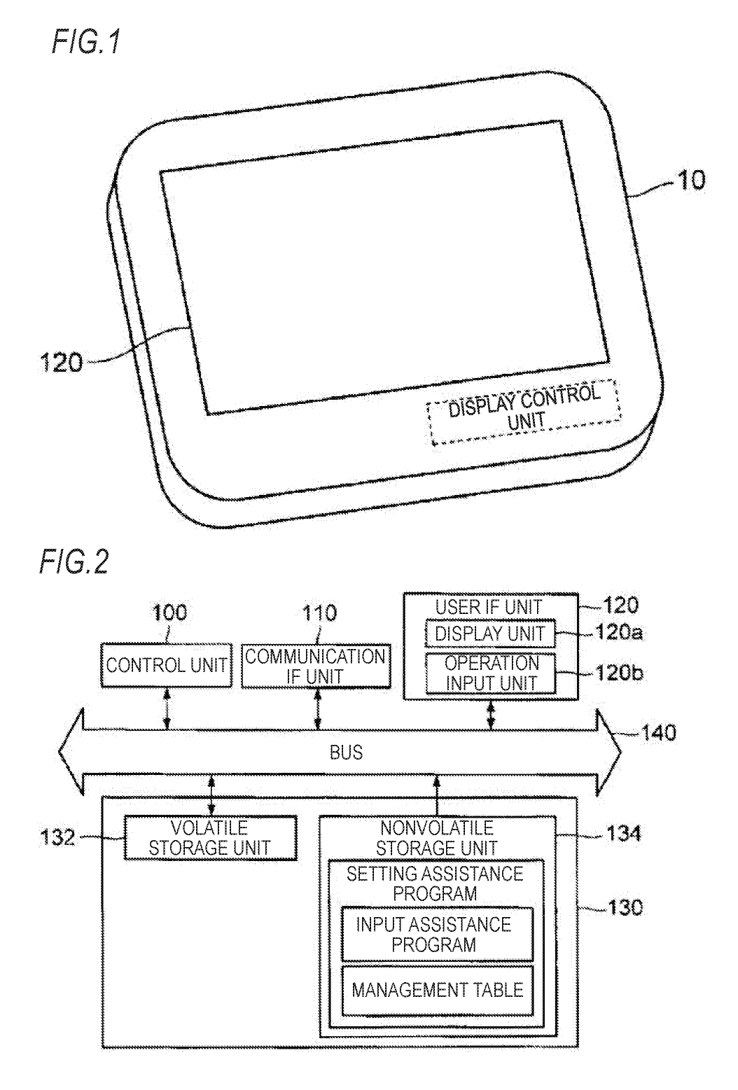

Hereinafter, embodiments of the present disclosure will be described with reference to the drawings. FIG. 1 is a perspective view illustrating an outline of an electronic device 10 according to an embodiment of the present invention. The electronic device 10 is, for example, a tablet terminal, and includes a user IF unit 120 such as a touch panel. A user of the electronic device 10 can enter various types of inputs by touching the user IF unit 120.

In the electronic device 10 of the embodiment, there is installed a setting assistance program to perform various types of settings (for example, settings of a filtering condition) on a network device such as a router. The user of the electronic device 10 can connect the electronic device 10 through a communication cable to the network device which is a target of a setting work (hereinafter, referred to as a setting target device), and can perform the setting work on the setting target device by performing the setting work according to the setting assistance program. In the embodiment, description will be given about a case where the electronic device 10 has a wired connection to the setting target device. However, a wireless connection may be employed.

The setting work is realized by inputting various types of commands and causing the electronic device 10 to operate according to the command. Similarly to the case of a general tablet terminal or a smart phone, the command input to the electronic device 10 is realized by inputting a character string indicating a command or an argument thereof (hereinafter, both will be collectively referred to as “command character string”) through an operation on a virtual keyboard displayed in the user IF unit 120. The electronic device 10 of the embodiment includes a display control unit which controls displaying of various types of screens to prompt the user to input the command character string. Therefore, the user can input the command character string with efficiency more than the related art. Hereinafter, a configuration (hardware configuration and software configuration) of the electronic device 10 will be described in detail with reference to the drawings.

FIG. 2 is a block diagram illustrating an exemplary configuration of the electronic device 10. As illustrated in FIG. 2, the electronic device 10 includes a control unit 100, a communication IF unit 110, a storage unit 130, and a bus 140 through which data is exchanged between these various types of elements, in addition to the user IF unit 120.

The control unit 100 is, for example, a CPU (Central Processing Unit). The control unit 100 supports the setting work by executing the setting assistance program. The setting assistance program is stored in the storage unit 130 (more specifically, a nonvolatile storage unit 134). The setting assistance program includes an input assistance program which causes the control unit 100 to execute the support the input of the command character string.

The communication IF unit 110 is, for example, an NIC (Network Interface Card). The communication IF unit 110 is connected to the setting target device through the communication cable for example. The communication IF unit 110, on one hand, passes data received from the setting target device through the communication cable to the control unit 100, and on the other hand, transmits the data received from the control unit 100 to the setting target device through the communication cable. In a mode where the electronic device 10 is wirelessly connected to the setting target device, a wireless LAN IF wirelessly communicating with an access point of a wireless LAN may be used as a communication IF unit 110.

The user IF unit 120 includes a display unit 120a and an operation input unit 120b as illustrated in FIG. 2. The display unit 120a is a drive circuit which performs a drive control with respect to a display device such as a liquid crystal display (not illustrated in FIG. 2). The display unit 120a displays images indicating various types of screens under the control of the control unit 100. As an example of a screen displayed in the display unit 120a, there is a screen to prompt the user to perform the setting work.

The operation input unit 120b is a transparent position detecting sensor in a sheet shape which is provided to cover the display screen of the display unit 120a. The position detecting method of the position detecting sensor may be an electrostatic capacitive type or an electromagnetic induction type. The operation input unit 120b forms a touch panel together with the display unit 120a. The user may perform various types of input operations by touching the operation input unit 120b using a touch pen or a fingertip, or by moving the fingertip while touching to perform a flicking. The operation input unit 120b assigns operation content data (for example, coordinate data such as a touch position in a two-dimensional coordinate space with the left upper corner or the like of a display screen of the display unit 120a as the origin point) indicating a touch position or a trajectory of a flicking operation to the control unit 100 using the fingertip of the user. Therefore, a user's operation content is transferred to the control unit 100.

The storage unit 130 includes a volatile storage unit 132 and the nonvolatile storage unit 134. The volatile storage unit 132 is, for example, a RAM (Random Access Memory). The volatile storage unit 132 is used by the control unit 100 as a work area when various types of programs are executed. The nonvolatile storage unit 134 is, for example, a flash ROM (Read Only Memory) or a hard disk. Various types of programs are stored in the nonvolatile storage unit 134. As a specific example of the program stored in the nonvolatile storage unit 134, there are a kernel which realizes an OS (Operating System) in the control unit 100, a web browser, a mailer, and the setting assistance program described above.

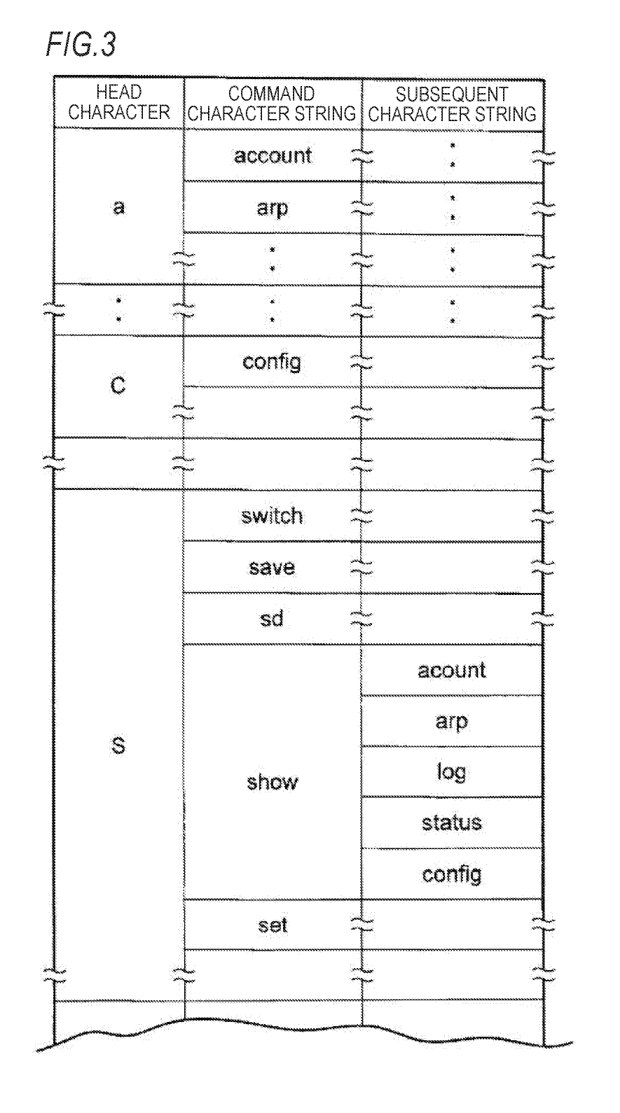

As illustrated in FIG. 2, the setting assistance program includes the input assistance program and a management table. FIG. 3 is a diagram illustrating an example of the management table. As illustrated in FIG. 3, in the management table, all the available command character string data indicating each commands and argument thereof for the setting work are grouped for each head character. As illustrated in FIG. 3, in each command character string data, there is stored subsequent character string data indicating other command character string (hereinafter, referred to as subsequent character string) which can be obtained with a space interposed in the command character string indicating the command character string data. For example, in a case where a word indicating the command character string data is a command, the subsequent character string data associated with the command character string data indicates an argument which can be designated to the command.

Making an explanation in detail, in the management table of the embodiment, the command character string data corresponding to each head character is stored in a descending order of the frequency of use in the setting work. The subsequent character string data corresponding to each command character string data is also stored in a descending order of the frequency of use as an argument in the setting work. The frequency of use in the setting work may be obtained using statistics for example. In the embodiment, the command character string data and the subsequent character string data are stored in the management table in the descending order of use in the setting work, but may be stored in a dictionary order such as an alphabetic order. Priority data indicating a priority corresponding to an order of the frequency of use or the dictionary order may be stored in the management table in association with each of the command character string data and the subsequent character string data.

The control unit 100 reads the kernel from the nonvolatile storage unit 134 to the volatile storage unit 132 by being triggered when the electronic device 10 is powered on (not illustrated in FIG. 2), and starts the operation of the kernel. The control unit 100, which operates according to the kernel and has an OS realized therein, can perform another program according to an instruction issued through the operation input unit 120b. For example, when a web browser is instructed to be executed through the operation input unit 120b, the control unit 100 reads the web browser from the nonvolatile storage unit 134 to the volatile storage unit 132, and starts the operation of the web browser. Similarly, when a setting assistance program is instructed to be executed through the operation input unit 120b, the control unit 100 reads the setting assistance program from the nonvolatile storage unit 134 to the volatile storage unit 132, and starts the operation of the setting assistance program.

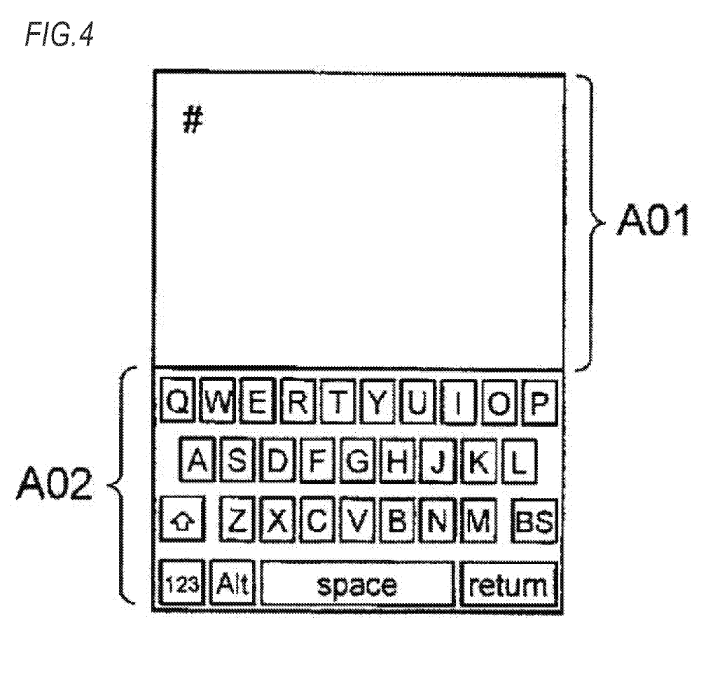

The control unit 100, which operates according to the setting assistance program, first causes the display unit 120a to display a command input screen A01 (see FIG. 4) which displays a command prompt (“#” in the example illustrated in FIG. 4) to prompt the user to input a command. Further, the control unit 100 starts the input assistance program to support a command input. The control unit 100 operating in accordance with the input assistance program serves as the display control unit described above.

In a process which is performed by the control unit 100 according to the input assistance program (hereinafter, referred to as an input assistance process), that is, the process performed by the display control unit, includes the following two steps. It is the point that is featured in the embodiment. In a first step, a plurality of pattern images each corresponding to a different character are displayed in the display unit 120a, and prompt the user to instruct the head character of a desired command character string. In a second step, a plurality of pattern images (hereinafter, the pattern images displayed in a first step will be referred to as “first pattern images”, and the pattern images displayed in a second step will be referred to as “second pattern images”) each corresponding to the command character string starting from a character corresponding to the designated pattern image are displayed with the first pattern image as a reference (center in the example, but not limited thereto) by being triggered when one of the plurality of pattern images displayed in the display unit 120a by the first step is designated. The user is prompted to input the command character string. Hereinafter, the input assistance process remarkably showing the feature of the embodiment will be described in detail.

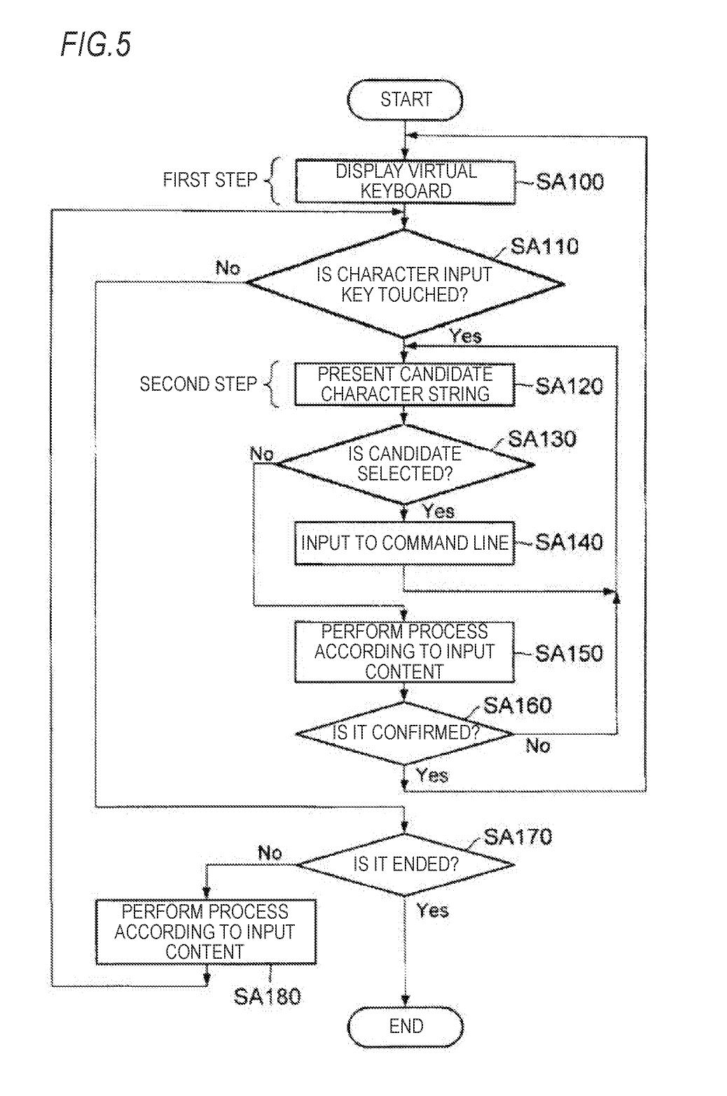

FIG. 5 is a flowchart illustrating a flow of the input assistance process. As illustrated in FIG. 5, the control unit 100 displays a virtual keyboard A02 in the command input screen A01 (see FIG. 4) and the display unit 120a to prompt the user to input a command (Step SA100). The process of Step SA100 is the first step. As illustrated in FIG. 4, a plurality of virtual operators are provided in the virtual keyboard A02. The plurality of virtual operators provided in the virtual keyboard are roughly classified into virtual operators corresponding to the characters of alphabets (the first pattern image; hereinafter referred to as a character input key) and other virtual operators. As a specific example of the other virtual operators, there are a virtual operator for inputting a special character such as a space (in the example illustrated in FIG. 4, the virtual operator assigned with a character string “SPACE”) and a virtual operator (in the example illustrated in FIG. 4, the virtual operator assigned with a character string “123”) for switching to a number input. The user who views the virtual keyboard A02 performs a touch operation on the character input key corresponding to the head character of a desired input command character string, and can input the head character. When the user performs the touch operation, the operation input unit 120b passes the operation content data indicating the touch position to the control unit 100.

In Step SA110 subsequent to Step SA100, the control unit 100 is on standby for the operation input unit 120b to pass the operation content data. When receiving the operation content data, the control unit 100 determines an operation content of the user with reference to the operation content data. Making an explanation in detail, the control unit 100 determines whether a coordinate position indicating the operation content data passed from the operation input unit 120b is a position corresponding to any one character input key, or a position of any one of the other virtual operators. In the former case, the control unit 100 determines that the touch operation is performed on the character input key. In the latter case, the control unit 100 determines that the touch operation is performed on the other virtual operator. In a case where the coordinate position indicating the operation content data passed from the operation input unit 120b is not a position of the character input key, and not the positions of the other virtual operators, the control unit 100 considers that the touch operation is an invalid operation, and waits for the input again.

In a case where a determination result of Step SA110 is “No” (that is, the touch operation is performed on the other virtual operators), the control unit 100 determines whether the operation is to instruct a setting assistance program to be ended (Step SA170). In a case where the determination result is “Yes”, the command input screen A01 and the virtual keyboard A02 are deleted from the display screen of the display unit 120a, and the input assistance program and the setting assistance program are ended. In a case where the determination result of Step SA170 is “No”, the control unit 100 performs a process in accordance with an operation content (Step SA180), and performs the process of Step SA110 again. For example, in a case where there is a touch operation on the virtual operator to switch a number input, the control unit 100 switches the virtual keyboard A02 into a virtual keyboard for the number input in Step SA180, and performs the process of Step SA110 again.

In a case where the determination result of Step SA110 is “Yes” (that is, it is determined that there is a touch operation on any one of the character input keys), the control unit 100 performs Step SA120 and the subsequent processes. In Step SA120, the control unit 100 narrows down the candidates of a user's input command character string from a user's operation content, and presents the candidates to the user and waits for a user's operation. The process of Step SA120 is the second step. In Step SA120, the control unit 100 specifies a character corresponding to the character input key which is touched by the user, reads the command character string data indicating the command character string starting from the character from the management table, and presents the command character string indicating the command character string data as the candidates of the user's input command character string.

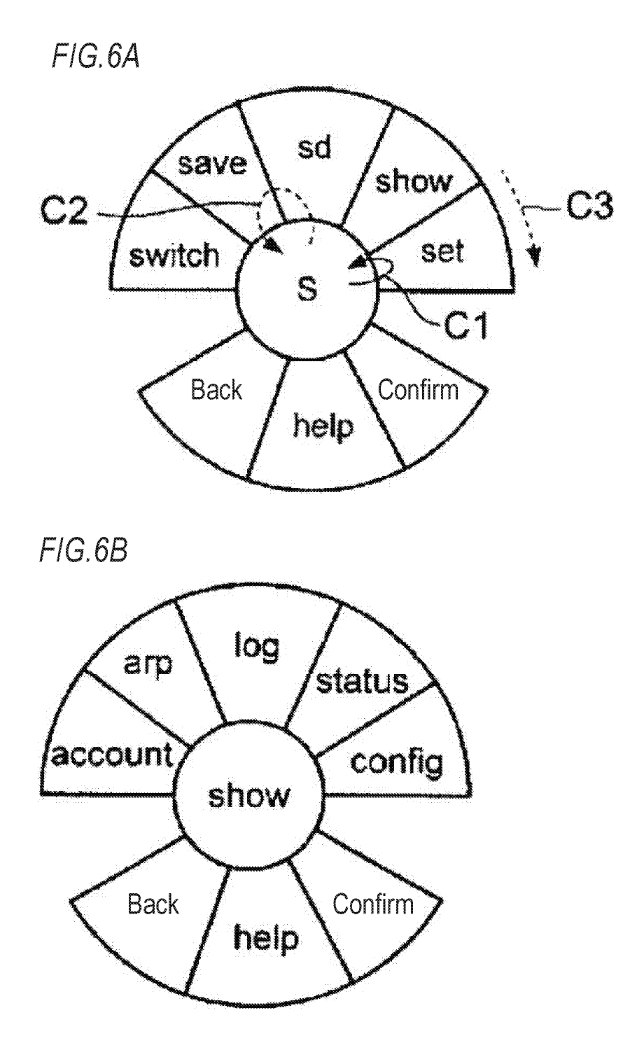

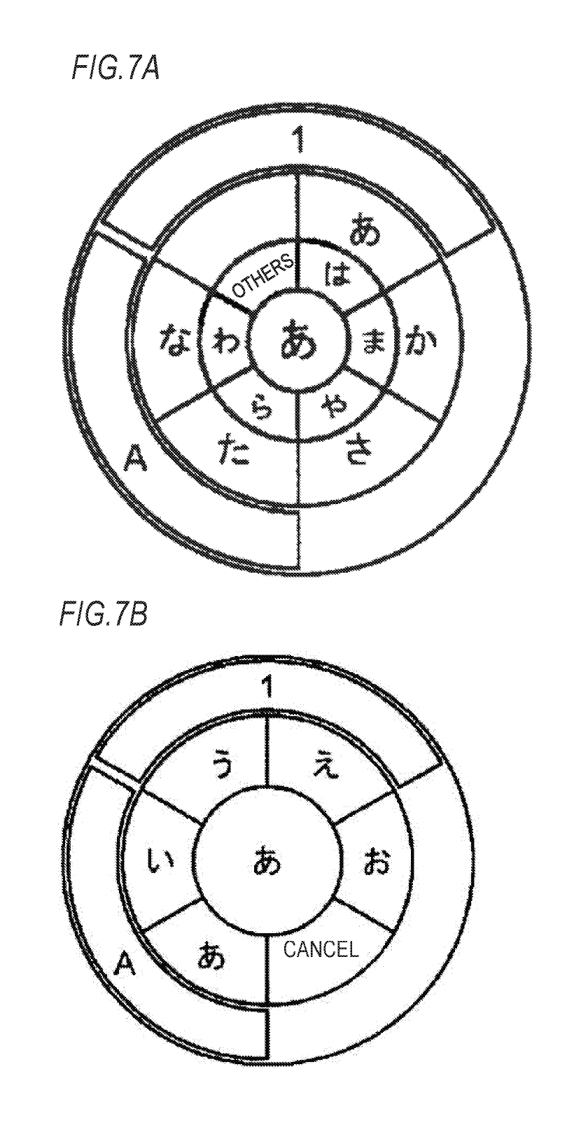

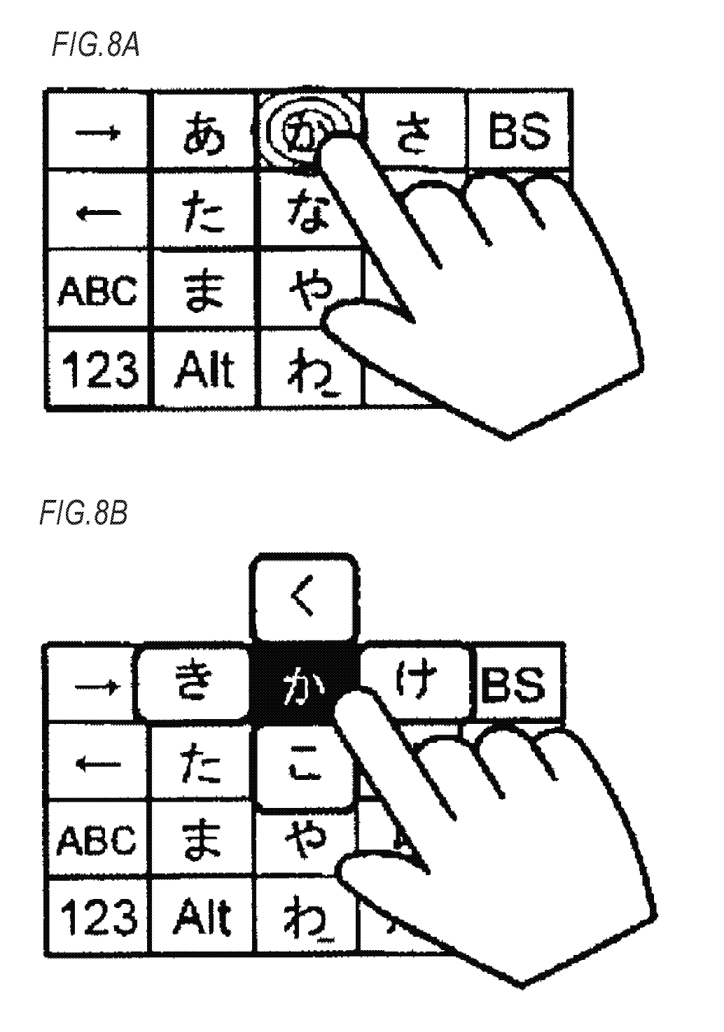

Making an explanation in detail, the control unit 100 causes the display unit 120a to display the pattern image (the second pattern image) of an approximate fan shape assigned to the command character string indicating the command character string data read out of the management table in the above manner. At this time, the control unit 100 causes the display unit 120a to display a predetermined number of the approximate fan-shaped pattern images in a clockwise direction from 9 o'clock position with the touched character input key as a center. For example, in a case where the character designated by the touch operation is “s”, the image surrounding the virtual operator corresponding to the character “s” is updated as illustrated in FIG. 6A. FIG. 6A illustrates an example in which five second pattern images are disposed surrounding the character input key corresponding to the character designated by the touch operation (that is, the predetermined number of pattern images is five). However, the number of command character strings starting from the character may be six or more. In this case, the respective pattern images corresponding to the sixth and subsequent command character strings may be displayed in scroll by being triggered when the lower end of the second pattern image corresponding to a lowest-priority command character string (“set” in the example illustrated in FIG. 6A) in the second pattern images displayed in the display unit 120a is flicked (see arrow C3 in FIG. 6A). The pattern image assigned to the character “back” in FIG. 6A is a virtual operator that the user can cancel input. The pattern image assigned to the character string “help” is a virtual operator that the user can view a help screen. The pattern image assigned to the character “confirm” is a virtual operator that the user can perform a command of input completion to the command prompt of the command input screen A01. In this way, the second pattern image corresponding to the command character string and the second pattern corresponding to the virtual operator may be displayed in regions separated from each other. In other words, the second pattern images displayed in the separated regions are displayed to prompt the user to input a word corresponding to a different type of process for each region.

The user who recognizes the image illustrated in FIG. 6A may select a desired command character string by a flicking operation on the second pattern image. For example, in a case where the user desires to input “set” as the command character string, the user slides the fingertip touched on the virtual operator corresponding to the character “s” toward the pattern image assigned to the character string “set”, and performs an operation (the flicking operation illustrated by a trajectory with arrow C1 in FIG. 6A) to return to the virtual operator corresponding to the character “s” so as to select the character string “set”. In a case where the user performs an operation to return to the first pattern image through the plurality of second pattern images like the flicking operation illustrated by a trajectory with arrow C2 in FIG. 6A, it may be determined that the command character string “save” corresponding to the second pattern image passed immediately before returning to the first pattern image is selected. In order to explicitly represent a selected command character string to the user by the flicking operation, the second pattern image where the fingertip of the user is located may be inversely displayed.

In Step SA130 subsequent to Step SA120, the control unit 100 determines whether the user selects a candidate with reference to the operation content data which is passed from the operation input unit 120b. In a case where the determination result of Step SA130 is “Yes”, the control unit 100 inputs the command character string selected by the user to the command prompt (also referred as a command line) of the command input screen A01 (Step SA140), and performs the process of Step SA120 again. However, in Step SA120 performed after Step SA140, the control unit 100 reads the subsequent character string data stored in the management table in association with the command character string data indicating the command character string selected right before, and presents the command character string indicating the subsequent character string data as the candidate of the command character string which the user inputs.

For example, it is assumed that the command character string selected by the flicking operation is “show”. In the management table of the embodiment as illustrated in FIG. 3, the subsequent character string data indicating the character strings “account”, “arp”, “log”, “status”, and “config” is stored in the command character string data which indicates the command character string “show”. Therefore, the control unit 100 displays the pattern image assigned with the command character string “show” at a position of the virtual operator corresponding to the character “s”, displays the pattern images assigned with the character strings of “account”, “arp”, “log”, “status”, and “config” surrounding the command character string “show” (see FIG. 6B), and prompts the user to select a command character string following the command character string “show”.

In a case where the determination result of Step SA130 is “No” (that is, the operation content of the user is a touch operation on any one of the virtual operators “back”, “help”, and “confirm”), the control unit 100 performs a process according to the operation content of the user (Step SA150). For example, in a case where the operation content of the user is a touch operation on a “help” key, the control unit 100 causes the display unit 120a to display the help screen. In Step SA160 subsequent to Step SA150, in a case where the operation content of the user is a touch operation on “confirm” key and the determination result is “Yes”, the command input is considered as being finished, and Step SA100 and the subsequent processes are performed again. On the contrary, in a case where the determination result of Step SA160 is “No”, the control unit 100 considers that the command input is ongoing, and performs SA120 and the subsequent processes. Hitherto, the flow of the input assistance process in the embodiment is described.

Herein, the point that should pay attention to is that, according to the embodiment, there is no need to input the characters of the command character string one by one, so that time to input the command is significantly reduced. There is no need to take the fingertip off from the operation input unit 120b until the command character string by the flicking operation is selected after the head character of a desired command character string and until the subsequent character string of the command character string is selected. Therefore, the number of times of touching on the operation input unit 120b is reduced compared to the mode that the command character string of the input candidate is displayed in a separate frame, and the input can be made with efficiency.

In this way, according to the embodiment, it is possible to efficiently input the command character string to the electronic device 10 using the virtual keyboard as an input unit.

Hitherto, the description is given about the embodiment of the present invention. The embodiment may be modified as follows.

(1) The embodiment described an example of applying the present invention to input assistance of the command character string. This is because the input to the setting assistance program (the caller of the input assistance program) is almost limited to the input of the command character string, and there occurs no significant problem even when the candidates designated by the user according to the user's designation of the head character are narrowed down in a range of the command character string. In short, if the candidates to be presented to the user according to the user's designation of the head character are narrowed down according to the type of an application to which a word is input, the application program is not limited to the setting assistance program.

The candidates to be presented to the user according to the user's designation of the head character may be narrowed down according to the type of input item to which the word is input instead of being narrowed down according to the type of the application program to which the word is input. For example, the present invention may be considered to be applied to a word input assistance of an address. In this case, the character string data indicating the name of prefecture is classified for each head character and stored in the management table. The subsequent character string data indicating the name of municipality which is associated with each character string data and belongs to the prefecture indicating the character string data is stored in the management table. The input assistance program may start by being triggered when the cursor is positioned in an address input column. A presenting order of the candidates to be presented to the user by displaying the second pattern image may be changed depending on the type of application program to which the word is input.

Further, the present invention is not limited to a case where the word candidates are presented or not and the presenting order is changed or not according to the type of an application program. The presentation of the word candidates and the presenting order may be changed depending on the types of control target device. For example, a network device and an audio device are different in device type. In this way, the operation target may be an application program or a device. Therefore, according to this example, the candidates of words may be presented according to an operation target, and the presenting order may be different.

(2) In the embodiment, the virtual keyboard A02 is displayed in the display unit 120a to prompt the user to designate the head character of a desired command character string. When the head character is designated, the plurality of second pattern images which correspond to the command character string starting from the character are displayed in a range of the first pattern image corresponding to the designated character so as to prompt the user to designate the command character string. However, the control unit 100 may be caused to perform Step SA140 and the subsequent processes of the flowchart illustrated in FIG. 5 to prompt the user to input the subsequent command character string (or edit the input command character string) by being triggered when any one of the input command character string to the command input screen A01 is designated. For example, an image illustrated in FIG. 6B may be overlapped with the command input screen A01 by being triggered when an operation of designating the command character string “show” (a touch operation to the place of the command input screen A01) is performed under a situation where #show log . . . is input to the command prompt of the command input screen A01.

(3) In the embodiment, the virtual keyboard A02 is displayed in the display unit 120a in order to prompt the user to designate the head character of a desired command character string. When the head character is designated, the plurality of second pattern images corresponding to the command character string starting from the character is displayed surrounding the first pattern image corresponding to the designated character so as to prompt the user to designate the command character string. However, when the designation of the command character string is prompted, the plurality of second pattern images displayed surrounding the user's designated first pattern image as a center may correspond to the command character string in which any one of the characters is matched with the character corresponding to the first pattern image. In short, the virtual keyboard A02 is displayed in the display unit 120a in order to urge the user to designate the character related to a desired input word. When a character is designated, the plurality of second pattern images corresponding to the word related to the character surrounding the first pattern image corresponding to the designated character are displayed, and may prompt the user to designate the word.

(4) The embodiment described an example of applying the present invention to word input assistance with respect to the tablet terminal. However, target application of the present invention is not limited to the tablet terminal. In short, the present invention may be applied as long as an electronic device uses a virtual keyboard as the input unit such as a smart phone, a PDA (Personal Digital Assistant), and a portable game console, so that the user can input each word of a command and an address with efficiency.

(5) In the embodiment, a display control unit is configured by a software module to perform the input assistance process (input assistance method) which apparently shows the feature of the present invention. However, the display control unit may be configured by a hardware module such as an electronic circuit. The electronic circuit may be a circuit configured by an FPGA (Field Programmable Gate Array). An input assistance device having the display control unit may be provided as a single body.

As described above, an embodiment of the present invention provides an input assistance device which includes the following display control unit. The display control unit performs a process (the process of the first step) to display a plurality of first pattern images each corresponding to a different character to the display unit (for example, a display device which roles as a display unit in the electronic device). Next, the display control unit is triggered when any one of the plurality of first pattern images displayed by the display device is designated, to perform a process (the process of the second step) of displaying the plurality of second pattern images corresponding to the word related to the character of the designated first pattern image surrounding the first pattern image as a center so as to prompt the user to input the word. As a specific example of the word corresponding to the second pattern image, that is, the word related to the character of the designated first pattern image, there is a word in which any character is matched with the character corresponding in the first pattern image such as a word starting from the character corresponding to the first pattern image. The word in which any character of the word is matched with the character corresponding in the first pattern image designated by the user is called “the word including the character”. The word related to the character of the designated first pattern image is not limited to the word including the character corresponding to the first pattern image. For example, in a case where the characters corresponding to the plurality of first pattern images are the head characters (that is, “ [symbol] (a)”, “ [symbol] (ka)”, “ [symbol] (sa)”, “ [symbol] (ta)”, “ [symbol] (na)”, “ [symbol] (ha)”, “ [symbol] (ma)”, “ [symbol] (ya)”, “ [symbol] (ra)”, “ [symbol] (wa)”) of columns of the Japanese syllabary, a word containing each character of the column corresponding to the character of the designated first pattern image may be set as the related word. For example, in a case where the character corresponding to the first pattern image designated by the user is “ [symbol] (a)”, the second pattern images corresponding to a word which is matched with any one of the characters (that is, “ [symbol] (a)”, “ [symbol] (i)”, “ [symbol] (u)”, “ [symbol] (e)”, “ [symbol] (o)”) belonging to the column of “ [symbol] (a)” may be displayed surrounding the first pattern image.

According to the present invention, when the first pattern image corresponding to the character related to a desired word is selected by the user using the fingertip, the second pattern images corresponding to the plurality of words related to the character corresponding to the first pattern image are displayed surrounding the first pattern image. The user moves the fingertip toward the second pattern image corresponding to a desired word among the plurality of displayed second pattern images so as to input the word. As described above, in the related art, there is the problem that “there is a need to perform the operation plural times to input one character”, and also there is the problem that “there is a need to perform many operations (touch operations) to input one word”. On the contrary, according to the present invention, there is no need for the user to sequentially input the characters of a desired word (or the reading syllabary of the word), and the word can be input by a less number of operations compared to the related art. Therefore, the above two problems can be solved at the same time. Of course, even in the related art disclosed in Patent Literature 1, the candidates of the word starting from the character designated by the user is displayed in a frame separated from the virtual operator corresponding to the character. However, in such a mode, the touch operation is necessarily performed when one of the presented candidates is designated. Therefore, the input efficiency cannot be improved as much as the present invention.

In the present invention, various modes may be considered for selecting the candidates of the word to prompt the user to select, by being triggered when the touch operation is performed on the first pattern image. For example, there may be considered a mode in which the display control unit selects a candidate presented to the user by displaying the second pattern image according to the type of the application program of a word input destination or the type of an input item to which the word is input (both will be collectively referred to as “type of the application of word input destination”). This is because the word input by the user can be considered to be narrowed down to some degrees according to the type of the application. For example, if the application program of the word input destination is a program which causes a computer to execute a process according to an input command, the word input by the user is considered as any one of the commands (or the arguments thereof). In a case where the input item is an address input column, the word input by the user is considered as the name of prefecture and the name of municipality.

In a preferred mode, where an upper limit value of the number of second pattern images displayed surrounding the first pattern image is set in advance, when the number of candidates of the word starting from the character corresponding to the first pattern image designated by the user exceeds the upper limit value, the display control unit switches the second pattern image displayed surrounding the first pattern image according to the user's operation. According to such a mode, even if a tablet terminal or a smart phone equipped with a display screen restricted in size is employed as the input assistance device of the present invention, the user can input a word with efficiency regardless of the restriction. In this case, a presenting order of the candidates shown to the user by displaying the second pattern image in the second step may be changed depending on the type of the application of the word input destination.

In a more preferred mode, the display control unit in the input assistance device of the present invention has the feature of performing a following third step other than the first and second steps. The display control unit performs the process of the third step by being triggered when the plurality of second pattern images displayed by the display device is selected in the second step. In the third step, the display control unit displays a third pattern image corresponding to the selected word at the position of the first pattern image, and displays a fourth pattern image which shows a candidate of a word (subsequent word) subsequent to the word surrounding the third pattern image as a reference (center in the example, but not limited thereto). According to such a mode, it is possible to input the subsequent word even if the characters of the subsequent word (or the reading syllabary of the subsequent word) is not input one by one. Therefore, the input efficiency of the word can be improved still more.

According to the present invention to solve the above problems, there is provided an input assistance method. The input assistance method includes the first step of causing the display device to display the plurality of first pattern images each corresponding to different characters, and the second step which is performed by being triggered when any one of the plurality of first pattern images displayed by the display device in the first step is designated. In the second step, the plurality of second pattern images each corresponding to the words related to the character of the designated first pattern image are displayed surrounding the first pattern image as a center to prompt the input of a word. Even when such an input assistance method is performed by the electronic device using the virtual keyboard as the input unit, the word indicating various types of data can be efficiently input to the electric device.

In order to solve the above problem, the present invention may provide a program causing a general computer such as the CPU to perform the input assistance method, that is, a program causing the CPU to perform the first and second steps. This is because by operating the control unit (CPU) such as an existing tablet terminal and an existing smart phone according to the program, it is possible to improve the efficiency when a word indicating various types of data is input to the existing tablet terminal and the existing smart phone. As a specific providing mode of the program, the program may be distributed by storing in a type of a computer-readable recording medium such as a CD-ROM (Compact Disk-Read Only Memory) and a flash ROM (Read Only Memory), or may be downloaded through electronic telecommunication circuit such as the Internet.

Reference signs used in the specification and drawings are listed as below.
10: electronic device
100: control unit
110: communication I/F unit
120: user IF unit
130: storage unit
132: volatile storage unit
134: nonvolatile storage unit
140: bus

What is claimed is:

1. An input assistance device comprising:
at least one memory storing instructions; and
at least one processor configured to implement the stored instructions to execute a plurality of tasks, including:
a display control task which causes a display device to display a plurality of first pattern images each corresponding to a different character, and by being triggered when any one of the plurality of first pattern images is designated, to display a plurality of second pattern images each corresponding to a word related to the character of the designated first pattern image surrounding the first pattern image as a reference so as to prompt an input of a word.

2. The input assistance device according to claim 1, wherein the words corresponding to the second pattern images contain the character corresponding to the designated first pattern image.

3. The input assistance device according to claim 2, wherein the words corresponding to the second pattern images start from the character corresponding to the designated first pattern image.

4. The input assistance device according to claim 1, wherein the display control task selects candidates of words to be presented to a user in displaying the second pattern images according to a type of an operation target of a word input destination.

5. The input assistance device according to claim 1, wherein the display control task changes a presenting order of candidates to be presented to the user in displaying the second pattern images according to the type of the operation target of the word input destination.

6. The input assistance device according to claim 4, wherein the type of the operation target includes a type of an application.

7. The input assistance device according to claim 1, wherein an upper limit value of the number of the second pattern images displayed surrounding the first pattern image is set in advance, and
in a case where the number of candidates of a word starting from the character corresponding to the first pattern image designated by the user exceeds the upper limit value, the display control task switches the second pattern images to be displayed surrounding the first pattern image according to user's operation.

8. The input assistance device according to claim 1, wherein the display control task is triggered when there is an operation selecting the plurality of second pattern images displayed by the display device to display a third pattern image corresponding to the selected word at a position of the first pattern image, and displays a fourth pattern image indicating a candidate of a word subsequent to the selected word surrounding the third pattern image as a reference so as to prompt an input of a word subsequent to the selected word.

9. The input assistance device according to claim 1, further comprising:
a communication interface which is used to communicate with a network device, wherein
the display control task refers to a management table indicating a word subsequent to the selected word and prompts an input of the word, wherein the management table associates at least an available command character string in a setting work of the network device with a character string subsequent to the command character string.

10. The input assistance device according to claim 1, wherein the display control task divides a region surrounding the first pattern image into a plurality of regions separated from each other, and displays the second pattern images in the divided regions, and
the second pattern images displayed in the plurality of divided regions are displayed to prompt the user to input a word corresponding to a different type of process for each region.

11. A smart phone having functions of an input assistance device, the input assistance device comprising:
at least one memory storing instructions; and
at least one processor configured to implement the stored instructions to execute a plurality of tasks, including:
a display control task which causes a display device to display a plurality of first pattern images each corresponding to a different character, and by being triggered when any one of the plurality of first pattern images is designated, to display a plurality of second pattern images each corresponding to a word related to the character of the designated first pattern image surrounding the first pattern image as a reference so as to prompt an input of a word.

12. An input assistance method comprising:
displaying a plurality of first pattern images each corresponding to a different character by a display device; and
displaying, by being triggered when any one of the plurality of first pattern images is designated, a plurality of second pattern images each corresponding to a word related to the character of the designated first pattern image surrounding the first pattern image as a reference so as to prompt an input of a word.

13. The input assistance method according to claim 12, wherein the words corresponding to the second pattern images contain the character corresponding to the designated first pattern image.

14. The input assistance method according to claim 13, wherein the words corresponding to the second pattern images start from the character corresponding to the designated first pattern image.

15. The input assistance method according to claim 12, wherein candidates of words to be presented to a user in displaying the second pattern images are selected according to a type of an operation target of a word input destination.

16. The input assistance method according to claim 12, wherein a presenting order of candidates to be presented to a user in displaying the second pattern images is changed depending on a type of an operation target of a word input destination.

17. The input assistance method according to claim 15, wherein the type of the operation target includes a type of an application.

18. The input assistance method according to claim 12, wherein an upper limit value of the number of the second pattern images displayed surrounding the first pattern image is set in advance, and
in a case where the number of candidates of a word starting from the character corresponding to the first pattern image designated by the user exceeds the upper limit value, the second pattern images to be displayed surrounding the first pattern image are switched according to the user's operation.

19. The input assistance method according to claim 12, further comprising:
displaying, by being triggered when there is an operation selecting the plurality of second pattern images displayed by the display device, a third pattern image corresponding to the selected word at a position of the first pattern image; and
displaying a fourth pattern image indicating a candidate of a word subsequent to the selected word surrounding the third pattern image as a reference to prompt an input of a word subsequent to the selected word.
